(19) United States
(12) Patent Application Publication
(10) Pub. No.: US 2004/0109316 A1
(43) Pub. Date: Jun. 10, 2004

(54) Ornamental musical lamp

(76) Inventor: Chung-Kuei Lin, Hsinchuang City (TW)

Correspondence Address: VENABLE, BAETJER, HOWARD AND CIVILETTI, LLP, P.O. BOX 34385, WASHINGTON, DC, 20043-9998, US

(21) Appl. No.: 10/309,092

(22) Filed: Dec. 4, 2002

(51) Int. Cl. F21V 33/00

(52) U.S. Cl. 362/253; 362/351

(57) ABSTRACT

An ornamental musical lamp includes a cover having therein a music generating mechanism and a transmission system provided which is driven by the music generating mechanism. An outer tube rotated by the transmission system is securely connected to a bulb support. A bulb is received in the bulb support and is securely connected to a inner tube which is stationary relative to the outer tube. A lampshade is securely connected to the bulb support so that when the outer tube is rotated by the transmission system, the lampshade is rotated.

### BACKGROUND OF THE INVENTION

1. Field of the Invention

The present invention relates to an ornamental lamp, and more particularly to a lamp which is able to generate music while the lampshade of the lamp is rotating.

2. Description of Related Art

The purpose of a lamp is to light the dark so that the user is able to see things better. However, once the lamp is activated, the user seems to forget there is a lamp standing alone at a corner. The reason why the user forgets the existence of the lamp is that the lamp has only one purpose and once the purpose is accomplished, no one will care for the lamp again as long as the lamp keeps on serving its designated purpose.

Another thing is a music box. As a child, almost everyone has a music box as a present from the family members. When the music from the music box starts to sound, children concentrate on the music as well as the little figure dancing with the music until the music stops. Why is there so much difference between the children's attention to the lamp and the music box? It is because the lamp serves only one purpose and once the purpose is accomplished, the lamp is pretty dull and boring. On the contrary, the music box serves two different purposes: one is the music and the other one is the dancing figure, which deeply holds the user's attention. However, the music box serves only to amuse the user. The music box does not have any practical application to our daily life despite its amusement effect.

To overcome the shortcomings, the present invention tends to provide an improved ornamental music lamp to mitigate and obviate the aforementioned problems.

### SUMMARY OF THE INVENTION

The primary objective of the present invention is to provide an improved ornamental music lamp having a music generating mechanism mounted on a base, a transmission system on top of the music generating mechanism and a lamp which is on top of the music generating mechanism and the transmission system. The lampshade is able to rotate when the music generating mechanism starts sending out music.

In order to accomplish the aforementioned objective, the lamp has an outer tube having a first end securely connected to a sun gear and a second end screwingly connected to a bulb support and an inner tube having a first end securely connected to a bulb which is rotatable relative to the bulb support and a second end securely mounted under the transmission system, wherein the bulb support securely connects to a lampshade. When the music generating mechanism rotates, a planetary gear connected to the music generating mechanism and meshed with the sun gear drives the sun gear to rotate, which also drives the outer tube as well as the lampshade to rotate.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the ornamental music lamp of the present invention;

FIG. 2 is an exploded perspective view of the ornamental lamp in FIG. 1;

FIG. 3 is a schematic view with partial in section showing the inner structure of the ornamental music lamp of the present invention; and

FIG. 4 is a schematic view of the rotation of the lampshade.

### DETAILED DESCRIPTION OF THE PREFERRED EMBODIMENT

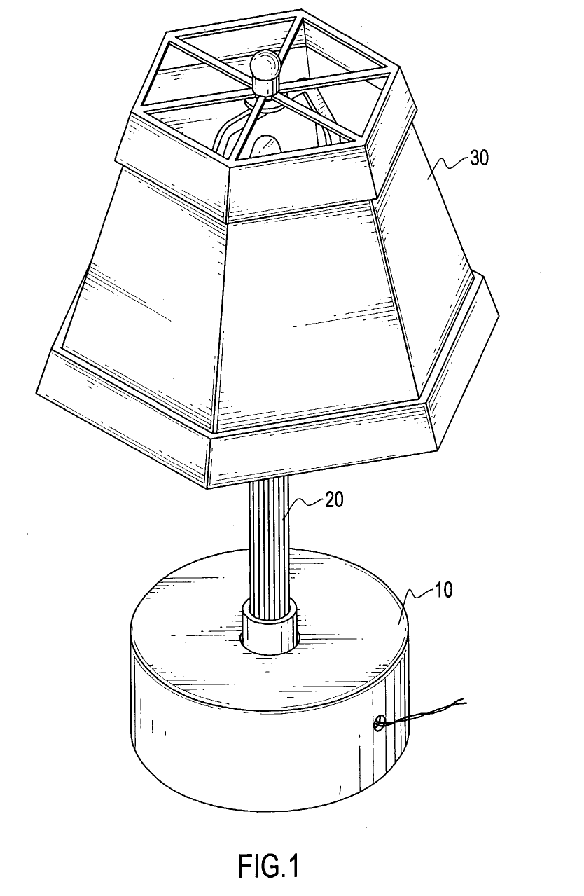

With reference to FIG. 1, the ornamental music lamp in accordance with the present invention has a cover (10), a supporting tube (20) and a lamp assembly (30).

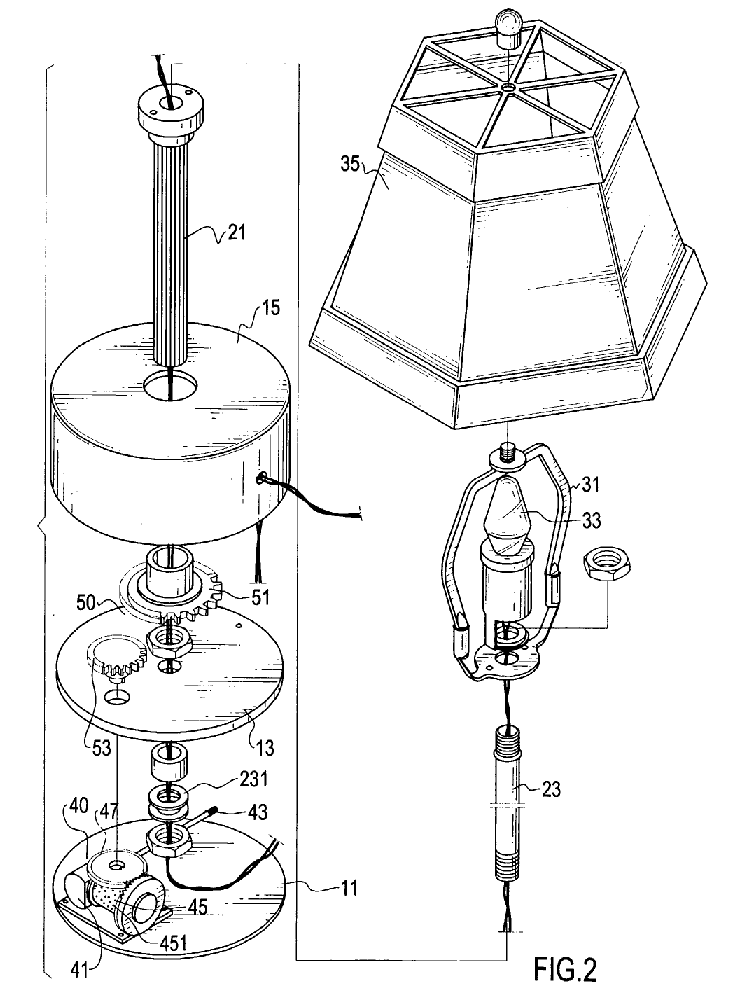

With reference to FIG. 2, the cover (10) includes a base (11), a music generating mechanism (40) securely mounted on the base (11), a separator (13), a transmission system (50) mounted on top of the separator (13) and a casing (15) enclosing the separator (13), the transmission system (50), the music generating mechanism (40) with the base (11). The music generating mechanism (40) includes a cylinder (41) having therein a spring (not shown) activated by a handle (43), a drum (45) rotatable relative to the cylinder (41) and having thereon multiple bosses (451) to be engaged with a pin (not shown) to sound pre-designated musical notes and a gear (47) driven by the spring in the cylinder (41).

The transmission system (50) includes a sun gear (51) and a planetary gear (53). The planetary gear (53) engages with the gear (47) so that when the gear (47) rotates, the planetary gear (53) is driven by the gear (47) to rotate as well. Further, due to engagement of the planetary gear (53) with the sun gear (51), the sun gear (51) also is activated to rotate.

The supporting tube (20) includes an outer tube (21) and an inner tube (23) received in the outer tube (21). The outer tube (21) has a first end securely connected to the sun gear (51) so that after the sun gear (51) is driven by the planetary gear (53) to rotate, the outer tube (21) rotates. The inner tube (23) has a first end extending through the casing (15), the sun gear (51) and the separator (13) to be securely connected to a nut assembly (231).

The lamp assembly (30) includes a bulb support (31), a bulb (33) and a lampshade (35). The bulb support (31) is securely connected to a second end of the outer tube (21) and the bulb (33) is securely connected to a second end of the inner tube (23). Furthermore, the lampshade (35) is securely connected to the bulb support (31).

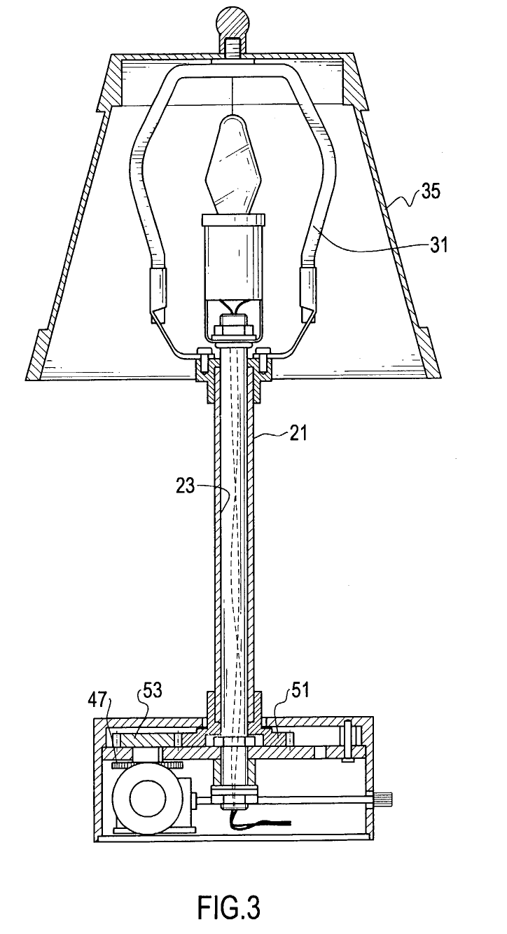

With reference to FIG. 3, after assembly, it is noted that the lampshade (35), the bulb support (31) and the outer tube (21) are securely connected with one another. Because the outer tube (21) is securely connected to the sun gear (51), rotation of the sun gear (51) drives the outer tube (21), the bulb support (31) and the lampshade (35) to rotate. At the same time, because the first end of the inner tube (23) is securely connected to the nut assembly (231) and the second end of the inner tube (23) is connected to bulb (33), the bulb (33) is stationary relative to bulb support (31).

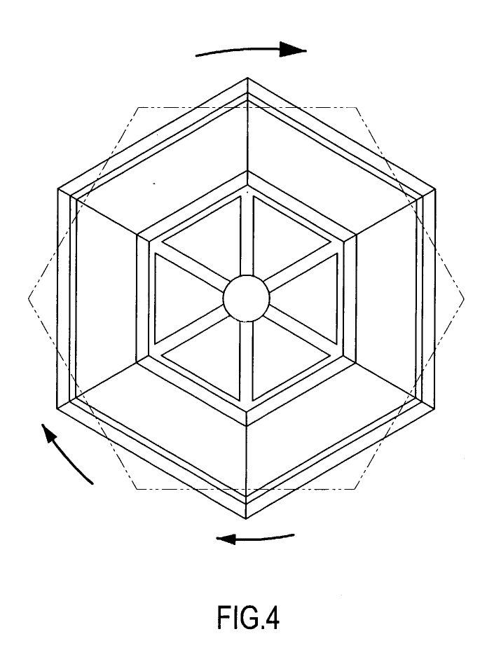

With reference to FIG. 4 and still taking FIG. 3 for reference, when the spring in the cylinder (41) is wound by the handle (43), the drum (45) is thus driven to rotate by the spring and the pin starts to engages with different bosses (451) on the periphery of the drum (45), which sends out musical notes to entertain the user. In the meantime, the driving force from the spring also drives the gear (47) to rotate, which in turn drives the sun gear (51) to rotate. Accordingly, the outer tube (21), the bulb support (31) and the lampshade (35) rotate, which creates an entertainment effect to the user.

In conclusion, the ornamental music lamp of the present invention presents not only musical entertainment, but also visual entertainment to the user so as to increase the attraction of a lamp.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An ornamental musical lamp comprising:
a cover having a base with a music generating mechanism securely mounted on top of the base and having a handle to control activation of the music generating mechanism, a separator securely provided on top of the base and a casing provided to enclose the separator with the base,
a transmission system provided on top of the separator and driven by the music generating mechanism, the transmission system being enclosed by the cover and having a sun gear and a planetary gear connected to the music generating mechanism;
an outer tube having a first end securely connected to the sun gear and a second end;
an inner tube received in the outer tube and having a first end and a second end, the first end of the inner tube securely connected to the separator;
a bulb support having a first end securely connected to the second end of the outer tube and a second end;
a bulb received in the bulb support and securely connected to the second end of the inner tube; and
a lampshade securely connected to the second end of the bulb support,
whereby after the sun gear is driven through the planetary gear by the music generating mechanism, the outer tube, the bulb support and the lampshade are rotated, and the music generating mechanism having a cylinder having therein a spring activated by a handle, a drum rotatable relative to the cylinder and having thereon multiple bosses to be engaged with a pin to sound pre-designated musical notes and a gear driven by the spring in the cylinder.

2. The ornamental music lamp as claimed in claim 1, wherein the first end of the inner tube is securely connected to the separator by a nut assembly.
